(19) United States
(12) Patent Application Publication
(10) Pub. No.: US 2023/0083977 A1
(43) Pub. Date: Mar. 16, 2023

(54) METHOD AND APPARATUS FOR IDENTIFYING A LOGIC DEFECT IN AN APPLICATION

(71) Applicant: Worcester Polytechnic Institute, Worcester, WA (US)

(72) Inventors: Craig Shue, Worcester, MA (US); Julian Lanson, Brighton, MA (US); Lane Harrison, Worcester, MA (US); Yunsen Lei, Worcester, MA (US); Matthew Puentes, Malden, MA (US)

(73) Assignee: Worcester Polytechnic Institute, Worcester, MA (US)

(21) Appl. No.: 17/939,254

(22) Filed: Sep. 7, 2022

Related U.S. Application Data
(60) Provisional application No. 63/242,595, filed on Sep. 10, 2021.

(51) Int. Cl. G06F 21/44; G06F 8/70

(52) U.S. Cl. CPC G06F 21/44; G06F 8/70; G06F 2221/2141

(57) ABSTRACT

Embodiments of the innovation relate to, in a webserver device, a method for identifying a logic defect in an application. The method comprises establishing a webserver instance of the webserver device with a client device, the webserver instance of the webserver device having a corresponding set of client device permissions; receiving a content request from the client device associated with the webserver instance of the webserver device; detecting a violation of a permission of the set of client device permissions associated with the webserver instance of the webserver device; identifying at least one webserver function associated with the violation of the permission of the set of client device permissions; and displaying a visual identification of the at least one webserver function associated with the violation of the permission of the set of client device permissions.

### RELATED APPLICATIONS

This patent application claims the benefit of U.S. Provisional Application No. 63/242,595, filed on Sep. 10, 2021 entitled “Software Defect and Incident Response Tool,” the contents and teachings of which are hereby incorporated by reference in their entirety.

### GOVERNMENT LICENSE RIGHTS

This invention was made with government support under Grant #1814402 awarded by the National Science Foundation. The government has certain rights in the invention.

### BACKGROUND

Conventional software development tools can include tools which allow software developers to identify the presence of errors within computer code. For example, Microsoft Visual Studio IDE Code Editor allows software developers to identify locations within software code where errors occur, thereby allowing the developers to diagnose and debug the application.

### SUMMARY

Conventional software development tools suffer from a variety of deficiencies. For example, software development tools such as Microsoft Visual Studio provide developers with the ability to visually identify syntax errors that occur within a set of code. However, these conventional development tools do not identify the presence of logic errors or defects within the code, which can be time consuming, relatively expensive, and difficult to detect. For example, application debugging can take between about 35-50% of developer time. Further, undetected logic errors within a set of software code instructions can lead to systemic security defects.

For example, certain applications, such as web-based applications, typically utilize a relatively complex software stack, with multiple servers interacting to retrieve or store database records, serve content to users, and to perform authentication. With such complexities, logic errors within a web-based application can go undetected. As such, adversaries can exploit these previously undetected logic errors within the web-based application and can attack the webserver on a regular basis. These attacks can lead to security breaches and potentially significant financial losses. Further, attack analysis and remediation on the part of the webserver can be complicated by adversary obfuscation, such as cover traffic, superfluous activity, or corruption of records, as well as by the difficulty in assembling and analyzing conventional webserver logs.

By contrast to conventional software development tools, embodiments of the present innovation relate to a method and apparatus for identifying a logic defect in an application. In one arrangement, the application defect identification tool can be executed by a computerized device, such as a webserver. During operation, in a process of dynamic analysis, the computerized device is configured to establish webserver instances for each client device and determine when an exploitation occurred, such as caused by a logic error in the application. Further, the computerized device is configured to record and review relevant actions for the webserver instance involved with the attack and to identify the webserver functions which allowed the attack to propagate within the system.

The application defect identification tool provides developers, such as webserver administrators, with a mechanism to mitigate software defects in their systems which can lead to full-system compromises. The tool mitigates the ability of a malicious web client to affect other users of the site. Further, the application defect identification tool provides a mechanism that allows webserver administrators to identify an adversary's initial intrusion and to remediate the defect. The application defect identification tool can further mitigate attack propagation and persistence on an affected system. It further allows analysts to quickly isolate defects. The application defect identification tool can mitigate breaches, which can cost organizations billions annually in aggregate and can reduce the time required for incident response by between about 93-96%.

Embodiments of the innovation relate to, in a webserver device, a method for identifying a logic defect in an application. The method comprises establishing a webserver instance of the webserver device with a client device, the webserver instance of the webserver device having a corresponding set of client device permissions; receiving a content request from the client device associated with the webserver instance of the webserver device; detecting a violation of a permission of the set of client device permissions associated with the webserver instance of the webserver device; identifying at least one webserver function associated with the violation of the permission of the set of client device permissions; and displaying a visual identification of the at least one webserver function associated with the violation of the permission of the set of client device permissions.

Embodiments of the innovation relate to a webserver device, comprising a controller having a memory and a processor, the controller configured to establish an webserver instance of the webserver device with a client device, the webserver instance of the webserver device having a corresponding set of client device permissions; receive a content request from the client device associated with the webserver instance of the webserver device; detect a violation of a permission of the set of client device permissions associated with the webserver instance of the webserver device; identify at least one webserver function associated with the violation of the permission of the set of client device permissions; and display a visual identification of the at least one webserver function associated with the violation of the permission of the set of client device permissions.

### BRIEF DESCRIPTION OF THE DRAWINGS

The foregoing and other objects, features and advantages will be apparent from the following description of particular embodiments of the innovation, as illustrated in the accompanying drawings in which like reference characters refer to the same parts throughout the different views. The drawings are not necessarily to scale, emphasis instead being placed upon illustrating the principles of various embodiments of the innovation.

FIG. 1 illustrates a schematic representation of a computer network having a webserver device configured to execute an application defect identification tool, according to one arrangement.

FIG. 2 illustrates a flowchart of a process performed by the webserver device of the computer network when executing the application defect identification tool of FIG. 1, according to one arrangement.

FIG. 3 illustrates a schematic representation of the computer network of FIG. 1, according to one arrangement.

FIG. 4 illustrates a schematic representation of the second middlebox and permission log of the webserver device of FIG. 1, according to one arrangement.

FIG. 5 illustrates a schematic representation of the webserver function log of the webserver device of FIG. 1, according to one arrangement.

FIG. 6 illustrates the display of application code associated with a webserver function having a logic error, according to one arrangement.

FIG. 7 illustrates a schematic representation of an annotation window provided by the webserver device of FIG. 1 according to one arrangement.

FIG. 8 illustrates a schematic representation of the display of details of a content request that exploited a logic defect of a webserver instance application, according to one arrangement.

FIG. 9 illustrates a schematic representation of the use of a probability statistic by the webserver device of FIG. 1, according to one arrangement.

### DETAILED DESCRIPTION

Embodiments of the present innovation relate to a method and apparatus for identifying a logic defect in an application. In one arrangement, the application defect identification tool can be executed by a computerized device, such as a webserver. During operation, in a process of dynamic analysis, the computerized device is configured to establish webserver instances for each client device and determine when an exploitation occurred, such as caused by a logic error in the application. Further, the computerized device is configured to record and review relevant actions for the webserver instance involved with the attack and to identify the webserver functions which allowed the attack to propagate within the system.

The application defect identification tool provides developers, such as web server administrators, with a mechanism to mitigate software defects in their systems which can lead to full-system compromises. The tool mitigates the ability of a malicious web client to affect other users of the site. Further, the application defect identification tool provides a mechanism that allows web server administrators to identify an adversary's initial intrusion and to remediate the defect. The application defect identification tool can further mitigate attack propagation and persistence on an affected system. It further allows analysts to quickly isolate defects. The application defect identification tool can mitigate breaches, which can cost organizations billions annually in aggregate and can reduce the time required for incident response by between about 93-96%.

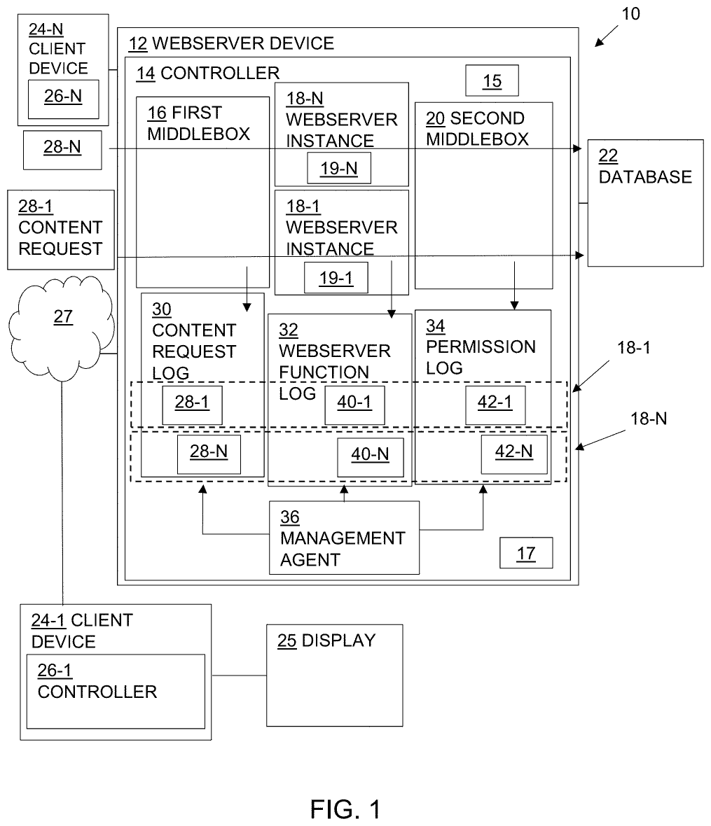

FIG. 1 illustrates a block diagram of a computer network 10, according to one arrangement. The computer network 10 can be configured in a variety of ways. For example, the computer network 10 can be configured as a local area network (LAN), such as within an enterprise. In another example, the computer network 10 can be configured as a wide area network (WAN), such as across multiple enterprises (e.g., the Internet).

The computer network 10 includes a set of network resources, such as one or more network devices or client devices 24, disposed in electrical communication with a server device, such as a webserver device 12, through a network 27. In one arrangement, each client device 24-1 through 24-N is configured as a computerized device, such as a laptop or personal computer, having a controller 26-1 through 26-N, respectively, such as a memory and a processor.

The webserver device 12 includes a controller 14, such as a memory and a processor, configured with a webserver application 15. When executed by the controller 14 of the webserver device 12, the webserver application 15 allows the webserver device 12 to receive content requests 28 from the client devices 24 and to serve the requested content from a database 22 in response to the requests 28. For example, the webserver device 12 can be configured to serve a website along with related content to a client device 14 in response to receiving a content request 28. Further, the webserver device 12 is configured with an application defect identification tool 17 which, when executed by the webserver device 12, can mitigate software defects, such as previously undetected defects, in the webserver application 15 which can lead to computer system 10 compromises.

In one arrangement, when executing the application defect identification tool 17, the webserver device 12 is configured to generate multiple webserver instances 18 of the webserver device 12 for each client device 24 disposed in electrical communication with the webserver device 12. For example, as shown in FIG. 1, in response to receiving a connection request from each client device 24-1, 24-N, the webserver device 12 establishes separate, corresponding webserver instances 18-1, 18-12 for each client device 24-1, 24-N. As such, each webserver instance 18 executes separate a copy of the webserver application 15 and, as such, the webserver device 12 can track its interactions with each client device 24-1, 24-N individually, thereby mitigating effects of client device interactions with a single webserver application 15.

The webserver device 12 is configured to associate particular client device permissions 19 for each webserver instance 18 based on a client identity associated with the client device 24. The client device permissions 19 define how each client device 24 can interact with the webserver device 12, as well as the types of information that the webserver device 12 can provide to each client device 24 from the database 22.

The webserver device 12 assigns a webserver instance 18 client device permissions 19 in response to the client device 24 logging into the webserver device 12. In one arrangement, each connection request transmitted to the webserver device 12 from each client device 24 can include client identification information. The webserver device 12 can utilize the client identification information to assign a particular client device permission 19 to a corresponding webserver instance 18. For example, assume the case where the webserver device 12 is configured to provide class grade information to the client devices 24. Accordingly, in the case where client device 24-1 provides a connection request which includes client identification information indicating the client device 24-1 as being associated with a student, the webserver device 12 can assign client device permissions 19-1 to the webserver instance 18-1 which establishes a set of rules that allows the client to view only his or her own grades for a class. However, in the case where client device 24-N provides a connection request which includes client identification information indicating the client device 24-N as being associated with the instructor, the webserver device 12 can assign client device permissions 19-N to the webserver instance 18-N which allows the client to view all grades for the class. As such, each client device 24 can interact with webserver device 12 according to particular client device permissions 19.

Further, when executing the application defect identification tool 17, the webserver device 12 can utilize middleboxes and the webserver instances 18 to log information pertaining to one or more content requests 28 originating from one or more of the client devices 24. With such logging, following detection of the exploitation of logic errors or defects associated with the webserver instance 18 execution of a copy of the webserver application 15, the webserver device 12 can review the logs to identify the client device permissions 19 that were violated, the functions associated with the webserver instances 18 that were involved in the logic error, and the content request 28 provided by the client device 24 that violated the client device permissions 19.

In one arrangement, the webserver device 12 includes a first middlebox 16 configured to receive content requests 28 from the client devices 24 and to provide the content requests 28 to the webserver instances 18 associated with the client devices 24. For example, the first middlebox 16 can provide content requests 28-1 from client device 24-1 to webserver instance 18-1 and can provide content requests 28-N from client device 24-N to webserver instance 18-N.

Further, for each webserver instance 18, the first middlebox 16 is configured to provide the content requests 28 from each client device 24 to a content request log 30. The content request log 30 stores each content requests 28 from each client device 24 for a corresponding webserver instance 18. For example, the first middlebox 16 can store a content request 28-1 from client device 28-1 as part of a first webserver instance 18-1 of the content request log 30 and can store a content request 28-N from client device 28-N as part of a second webserver instance 18-N of the content request log 30. As will be described below, with storage of the content requests 28 as part of the content request log 30, the webserver device 12 can identify a particular communication 28 provided by a client device 24 which exploited a logic defect associated with the webserver instance 18 executing a copy of the webserver application 15.

In one arrangement, the webserver device 12 includes a second middlebox 20 disposed between each webserver instance 18 and the database 22 and is configured to log interactions between each webserver instance 18 and the database 22. As illustrated, because each client device 24 interacts with its own webserver instance 18, the second middlebox 20 can identify cases where a content request 28 either meets or exceeds the client device permissions 19 for a particular webserver instance 18 and can store this information as permission comparison result 42 in a permission log 34. For example, the permission log 34 stores each permission comparison result 42 associated with each client device 24 for a corresponding webserver instance 18. For example, the second middlebox 20 can store a permission comparison result 42-1 associated with client device 28-1 as part of a first webserver instance 18-1 of the permission log 34 and can store a permission comparison result 42-N associated with client device 28-N as part of a second webserver instance 18-N of the permission log 34.

Additionally, when executing the application defect identification tool 17, the webserver device 12 can store identifications of webserver functions 40 associated with the processing of a content request 28 as part of a webserver function log 32. For example, in use, a webserver instance 18-1 can execute several functions, such as software code instructions, during the processing of a content request 28-1. In the event that the webserver device 12 detects the presence of a logic error defect associated with the webserver application 15 executed by the webserver instance 18-1, as indicated by the content request 28-1 exceeding the client device permissions 19-1 for the webserver instance 18-1, the identification of webserver functions 40 stored in the webserver function log 32 can identify the software code executed by the webserver instance 18-1, as well as the order of execution the time of the logic defect.

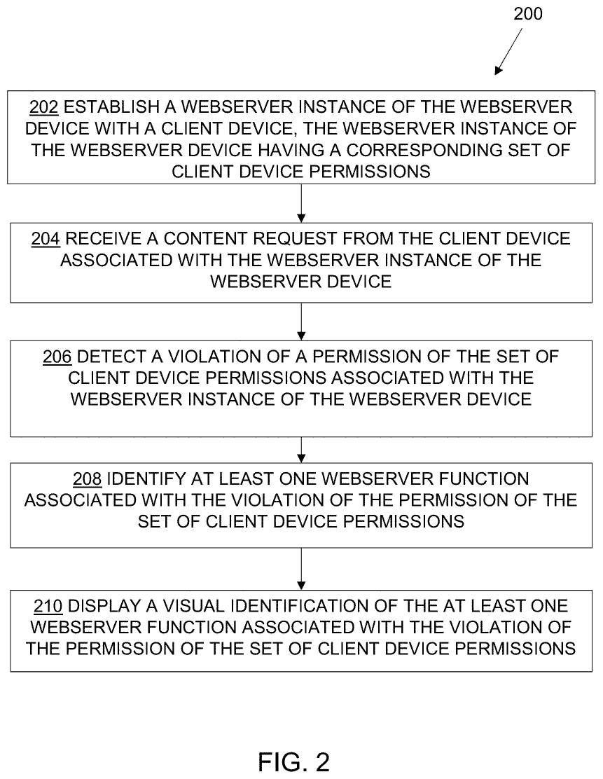

FIG. 2 illustrates a flowchart 200 of a process performed by the webserver device 12 of the when executing the application defect identification tool 17 and identifying a logic defect in the webserver application 15.

In element 202, the webserver device 12 establishes a webserver instance 18 of the webserver device 12 with a client device 24, the webserver instance 18 of the webserver device 12 having a corresponding set of client device permissions 19.

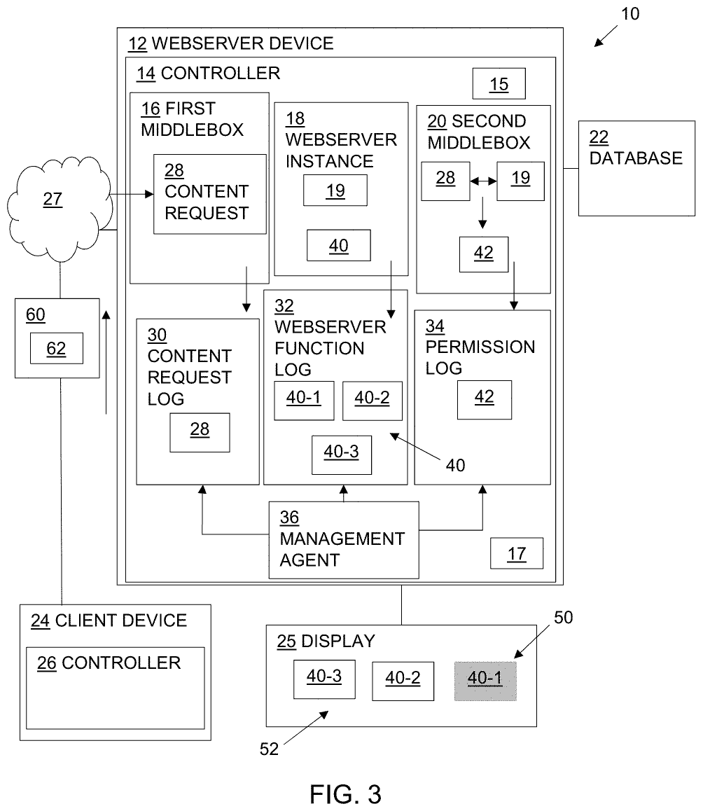

For example, with reference to FIG. 3, the client device 24 can initiates a connection with the webserver device 12 by transmitting a connection request 60 which includes client identification information 62. In response, the webserver device 12 can generate the webserver instance 18 of the webserver device 12 to execute a copy of the webserver application and can direct the client device 24 to communicate with the webserver instance 18. Additionally, the webserver device 12 can review the client identification information 62 and can assign a particular client device permission 19 to the webserver instance 18 based upon the information 62. For example, in the case described above, the webserver device 12 can be configured to provide class grade information to the client devices 24. In the case where client device 24-1 provides a connection request which includes client identification information 62 indicating the client device 24 as being associated with a student, the webserver device 12 can assign client device permissions 19 to the webserver instance 18 which establishes a set of rules which allows the client to view only his or her own grades for a class.

The webserver device 12 assigns a webserver instance 18 with client device permissions 19 in response to the client device 24 logging into the webserver device 12. In one arrangement, each connection request transmitted to the webserver device 12 from each client device 24 can include client identification information.

Returning to FIG. 2, in element 204, the webserver device 12 receives a content request 28 from the client device 24 associated with the webserver instance 18 of the webserver device 12.

For example, as indicated in FIG. 3, following receipt of the content request 28 by the webserver device 12, the first middlebox 16 reviews the content request 28 to identify the source of the request 28, in this case the client device 24, and forwards the content request 28 to the webserver instance 18 associated with that client device 24. Further, the first middlebox 16 stores the content request 28 for the webserver instance 18 of the webserver device 12 in the content request log 30.

In response to receiving the content request 28, the webserver instance 18 can execute one or more functions 40 based upon the content request 28 in order to process the request 28 and to obtain content from the database 22 related to the request. During the processing, the webserver instance 18 is configured to store an identification of the webserver functions 40-1, 40-2, 40-3 associated with processing the content request 28 for the webserver instance 18 of the webserver device 12 in a webserver function log 32. For example, the webserver instance 18 can store each function's call site (i.e., the file and line at which the function is called), each function's parameter values, and each function's definition location (i.e., the file and line range that implement the function).

In one arrangement, the webserver instance 18 can execute one or more functions 40 based upon the content request 28 regardless of the data provided as part of the content request. For example, webserver device 12 can be configured to provide class grade information to the client devices 24. In one case, assume that Student_1 utilizes the client device 24 and requests the grades for Student_1 as part of a proper content request 28 (e.g., a content request that comports with the client device permissions 19 associated with the webserver instance 18). In response to the request 28, the webserver instance 18 can execute a number of functions, such as functions 40-1 through 40-3, relative to the content request 28 and can provide the content request 28 towards the database 22. However, in a second case, assume that Student_1 utilizes the client device 24 and requests the grades for Student_1 OR Student_2 as part of an improper content request 28 (e.g., a content request that does not comport with the client device permissions 19 associated with the webserver instance 18). In response to the request 28, the webserver instance 18 can execute a number of functions, such as functions 40-1 through 40-3, relative to the content request 28 and can also provide the content request 28 towards the database 22.

Following processing of the content request 28, the webserver instance 18 directs the content request 28 to the second middlebox 20 towards the database 22. The second middlebox 20 is configured to store a permission comparison result 42 associated with the webserver instance 18 of the webserver device 12 in a permission log 34, the permission comparison result 42 based upon a comparison of the content request 28 and the set of client device permissions 19.

In one arrangement, following receipt of the content request 28, the second middlebox 20 reviews the content request 28 relative to the client device permissions 19 associated with the webserver instance 18 for a particular client device. For example, the webserver device 12 can be configured to provide class grade information to the client devices 24 and the webserver device 12 can establish client device permissions 19 for the client device 24 which allows Student_1 to access and review his own grades. In one case, assume that Student_1 utilizes the client device 24 and requests the grades for Student_1 as part of the content request 28. When the second middlebox 20 compares the content request (e.g., request grades for Student_1) 28 with the client device permissions 19 associated with the webserver instance 18 for that client device 24 (e.g., provide access to grades for Student_1), the middlebox 20 can generate a permission comparison result 42 which indicates that the content request 28 falls within the client device permissions 19 for the client device 24. As a result, the second middlebox can store a positive permission comparison result 42 in the permission log 34 as associated with the webserver instance 18.

However, in another case, assume Student_1 utilizes the client device 24 and requests the grades for Student_1 OR Student_2 as part of the content request 28. When the second middlebox 20 compares the content request (e.g., request grades for Student_1 OR Student_2) 28 with the client device permissions 19 associated with the webserver instance 18 for that client device 24 (e.g., provide access to grades for Student_1), the middlebox 20 can generate a permission comparison result 42 which indicates that the content request 28 exceeds the client device permissions 19 for the client device 24 (e.g., that the client device permissions 19 were violated). As a result, the second middlebox can store a negative permission comparison result 42 in the permission log 34 as associated with the webserver instance 18.

Returning to FIG. 2, in element 206, the webserver device 12 detects a violation of a permission of the set of client device permissions 19 associated with the webserver instance 18 of the webserver device 12.

As indicated above, the first middlebox 16, the webserver instance 18, and the second middlebox 20 provide information 28, 40, 42 to each of the aforementioned, respective logs 30, 32, 34. In one arrangement, the webserver device 12 includes, as part of the application defect identification tool 17, a management agent 36 configured to monitor the permission log 34 to detect instances where the second middlebox 20 has identified a negative permission comparison result 42 which represents a violation of a permission of the client device permissions 19.

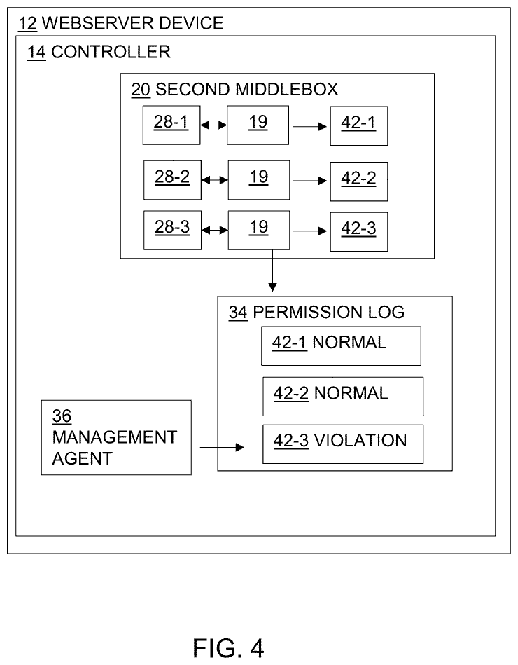

For example, FIG. 4 illustrates a case where the second middlebox 20 has received three content requests 28-1 through 28-3 from the webserver instance 18, as provided by client device 24. For the first two content requests 28-1, 28-2, client device 24 has requested the grades for Student_1. As with the previous example, when the second middlebox 20 compares each of the content requests 28-1, 28-2 with the client device permissions 19, the middlebox 20 can generate permission comparison results 42-1, 42-2 which indicates that the content requests 28-1, 28-2 fall within the client device permissions 19 for the webserver instance 18 of the client device 24. For the third content requests 28-1, 28-2, client device 24 has requested the grades for Student_1 OR Student_2. As this falls outside of the client device permissions 19 for the webserver instance 18 of the client device 24, when the second middlebox 20 compares the content request 28-3 with the client device permissions 19, the middlebox 20 can generate a permission comparison result 42-3 which indicates that the content request 28-3 violates the client device permissions 19 for the webserver instance 18 of the client device 24.

Accordingly, during operation, the management agent 36 is configured to review the permission comparison results 42 of the permission log 34 for each webserver instance 18 to identify violations. In the case where the permission log 34 includes a permission comparison result 42-3 that indicates a content request 28-3 falls outside of the client device permissions 19, the management agent 36 can detect a violation of a permission of the set of client device permissions 19.

Returning to FIG. 2, in element 208, the webserver device 12 identifies at least one webserver function 40 associated with the violation of the permission of the set of client device permissions 19.

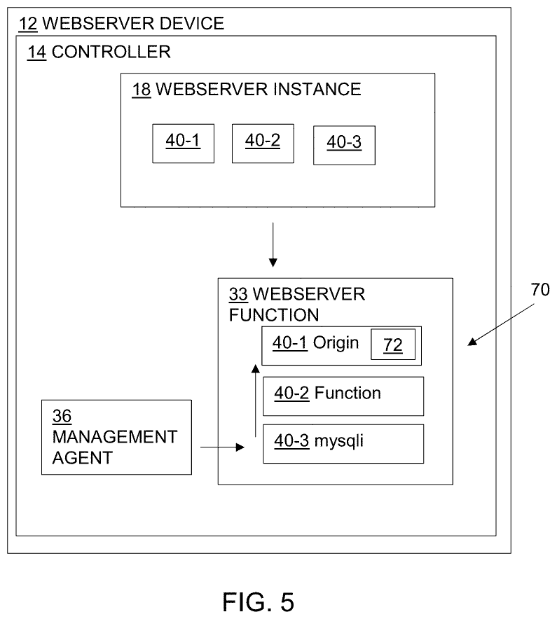

The generation of the negative permission comparison result 42-3 results, in part, from the webserver instance 18 executing one or more functions 40 which included a logic error that was exploited by the client device 24. In order to determine the function or functions 40 that include the logic error, with reference to FIG. 5, the management agent 36 can be configured to review the webserver function log 32 for the given webserver instance 18. Based upon this review, the management agent 36 is configured to identify the functions 40 of the webserver application code 15 which were executed by the webserver instance 18, which interacted with the content request 28-3, and which allowed the content request 28-3 to be passed to the database 22. As such the management agent 36 can reconstruct the chain of events which led to the content request 28-3, which falls outside of the client device permissions 19, being passed to the database 22 and as such can identify one or more of the functions 40 which include a logic defect.

The management agent 36 can be configured to identify these functions 40 which include a logic defect in a variety of ways. In one arrangement, the management agent 36 can be configured to identify a function calling pattern 70 of the set of webserver functions 40 that interacted with the content request 28-3 that violated the permission of the set of client device permissions 19.

With continued reference to FIG. 5, for example, the management agent 36 is configured to first review the functions 40 in the webserver function log 36 for a database request function 40-3. For example, the management agent 36 can search for a mysqli_query function 40-3 which is typically called by the webserver instance 18 to interact with or to query the database 22. The mysqli_query function 40-3 is a socket function that establishes a connection to the database 22. As such, the mysqli_query function 40-3 is indicative of an upstream function 40 that passed the content request 28-3 which exceeded the client device permissions 19.

Next, the management agent 36 is configured to identify one or more functions 40-2 which include the content request 28-3 that violated the client device permissions 19 and passed the content request 28-3 to the database request function 40-3. Functions that operate prior to the database request function 40-3, such as the mysqli_query function, provide content requests 28-3 to the database request function 40-3, which then provided to the database 22 by the database request function 40-3. As such, the management agent 36 can be configured to retrieve content request parameter values associated with the functions that provide content requests to the database request function 40-3. In the case where the management agent 36 identifies a match or correspondence between the content request parameter values (e.g., Student_1 OR Student_2) of a function 40 and a string included in the content request 28-3 (e.g., Student_1 OR Student_2) of the database request function 40-3, the management agent 36 can identify that function 40-2 as being part of the function calling pattern 70 involving the content request 28-3 that violated the client device permissions 19.

Next, the management agent 36 is configured to identify an origin webserver function 40-1 of the function calling pattern 70, the origin webserver function 40-1 defining a logic defect 72 relative to the content request 28-3 and associated with the violation of the permission of the set of client device permissions 19. For example, in order to determine where the logic defect 72 initially occurred, the management agent 36 is configured to reconstruct the function calling pattern for each function 40 stored in the webserver function log 32 for a webserver instance 18. By identifying the reverse order of the function calls associated with the webserver instance 18, the management agent is configure to reconstruct the chain of events and to identify the function calling pattern 70 which led to passing of the content request 28-3 to the database request function 40-3.

Further, the management agent 36 is configured to identify a content request 28-3 as originating from a particular function 40-1 by identifying the origin function 40-1 as having passed the content request 28-3 having the problematic string (e.g., Student_1 OR Student_2) but not as including the string as a content request parameter value. The management agent 36 can then define the function that does not include the problematic string but that passed the problematic string to a subsequent function as being the origin function 40-1 having the logic defect 72 which exceeding client permissions 19 associated with the client device 24.

Returning to FIG. 2, in element 208, the webserver device 12 displays a visual identification 50 of the at least one webserver function 40 associated with the violation of the permission of the set of client device permissions 19.

For example, with reference to FIG. 3, the webserver device 12 can assign a visual indicator 52 to each of the webserver functions 40-1, 40-2, 40-3 associated with the webserver instance 18, such as a square or rectangle shape. Further, the webserver device 12 can assign a particular pattern or color as the visual identification 50 to the functions 40 having the logic defect 72. For example, the type of pattern or color assigned to the functions can be indicative of the type of issue associated with the function. The webserver device 12 can then display each of the webserver functions 40-1, 40-2, 40-3 associated with the webserver instance 18 on a display 25 with a square or rectangle shape as the visual indicator 52. Further, the webserver device 12 can utilize a shading pattern as the visual identification 50 to identify the webserver functions associated with the logic defect 72, such as webserver function 40-1. With such display, the webserver device 12 provides an end user with the ability to identify the function 40-1 which requires revision or updating to mitigate further compromise by the client device 24.

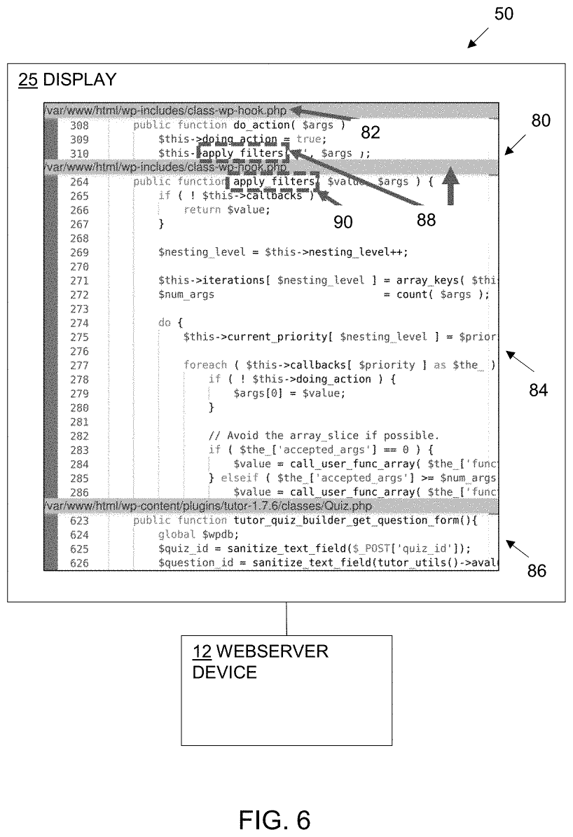

In one arrangement, when displaying a visual identification 50 of the webserver function 40 associated with the violation of the permission of the set of client device permissions 19, the webserver device 12 can display application code associated with the webserver function 40. For example, FIG. 6 illustrates an application code display 80 provided by the webserver device 12 on the display 25. As shown, the webserver device 12 provides the application code display 80 in a stack mode, such that the code executed as part of the function just prior to the detection of the security violation of the content request 28-3 is displayed. The webserver device 12 is configured to refrain from displaying the code that had not executed following detection of the security violation of the content request 28-3, since it could not have contributed to the defect. As illustrated, the stack mode splits the code view into multiple segments 82, 84, 86, each displaying the relevant implementation of each function 40. The last line 88 in each segment 82, 84, 86 is configured as a subsequent 90. With the webserver device 12 providing the application code display 80 in stack mode, an end user or developer can examine all the code executed before detection of the security violation of the content request 28-3 by scrolling a code view window from the top to bottom.

Following the display of the visual identification 50 of the webserver functions 40 associated with the violation of the permission of the set of client device permissions 19, the webserver device 12 can be configured to allow an end user or developer to provide annotations regarding the functions 40 to allow for later repair.

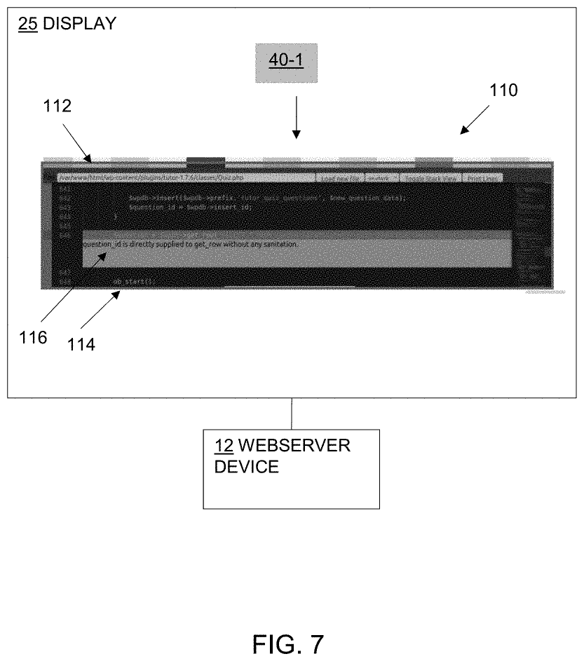

For example, with respect to FIG. 7, the webserver device 12 can provide the visual indicator 52 of the webserver function 40-1 associated with the violation of the permission of the client device permissions 19 as an executable link. When an end user executes the executable link associated with the webserver function 40-1, such as by using a cursor and clicking on the visual indicator 52 of the webserver function 40-1, the webserver device 12 displays an annotation window 110. The annotation window 110 provides, in a first window element 112, a portion of the code that includes the logic defect associated webserver function 40-1. The annotation window 110 further provides a second window element 114 which allows the end user to provide an annotation input 116 related to the logic defect. For example, as part of the annotation input 116, the end user can describe the logic defect as well as potential solutions. Following receipt of the annotation input 116, the webserver device 12 can store the input 116 for later use by the end user or developer when correction the logic defect associated with the webserver function 40-1.

As provided above, the webserver deice 12 is configured to display details of one or more webserver functions 40 that include a logic defect 72 which was exploited by a client device 24 via a particular content request 28-3. In one arrangement, the webserver device 12 is configured to identify and display the details of the content request 28-3 that exploited the logic defect 72.

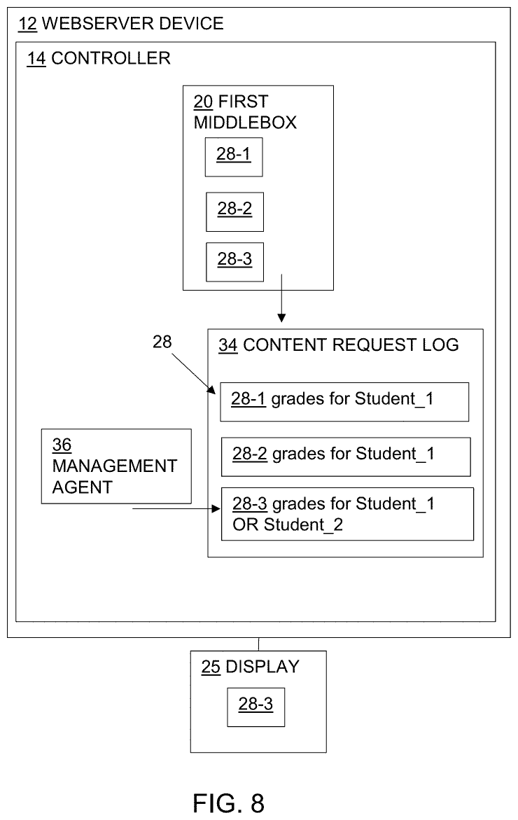

As provided above, in response to identifying a negative permission comparison result 42-3, the management agent 36 can then review the webserver function log 32 to identify one or more of the webserver functions 40 that had a logic defect exploited by a content request 28 that exploited the logic error. In one arrangement, and with reference to FIG. 8, following the identification of the webserver functions 40, the management agent 36 is configured to review the content request log 34 for content requests associated with a webserver instance 18 of the webserver device 12. For example, for a webserver instance 18, the first middlebox 16 has provided content requests 28-1 through 28-3 from the client device 24 to the content request log 34. Accordingly, a review of the content request log 34 by the management agent 36 can uncover content requests 28-1 through 28-3.

Next, following the review, the management agent 36 can identify the content request 28-3 associated with the violation of the permission of the set of client device permissions 19. For example, as provided above, when developing the function call pattern 70, the management agent 36 reviews the functions 40 associated with passing of the content request 28-3. During the identification process, the management agent 36 can compare the content request 28-3 identified by the functions 40 with the listing of content requests 28 in the content request log 34.

When the management agent 36 identifies a match between the content request 28-3 passed by the functions and content request 28-3 present within the content request log 34, the management agent 36 can review the content request 28-3 within the content request log 34 to identify the presence of an adversary supply input 120.

For example, when the user, Student 1, of the client device 24 provides a content request 28, such as content requests 28-1, 28-2, to the webserver device 12 to request the grades of Student_1, since these requests 28-1, 28-2 comport with the client device privileges 19 for the webserver instance 18 the management agent 36 can consider these as standard requests. However, in the case where Student 1 provides an SQL injection as a request 28-3, (e.g., grades for Student_1 OR Student_2), the management agent 36 is configured to identify such a string as an adversary supply input 120 that can induce a logic error in the webserver instance 18.

Next, the webserver device 12 can display the content request 28-3 that violated the permission of the set of client device permissions 19, such as on display 25. By outputting the content request 28-3 in such a manner, an end user or developer, can identify the type of content requests 28 which can exploit a logic defect 72 in the webserver instance 18 and can take appropriate steps to mitigate further exploitation.

As provided above, the webserver device 12 via the management agent 36 is configured to identify the function calling pattern 70 of the webserver functions 40 stored in the webserver function log 32 and to display each of the functions 40 associated with the webserver instance 18. However, in certain cases, a relatively large number of webserver functions 40 can be involved as part of the function calling pattern 70. In one arrangement, the webserver device 12 is configured to reduce the number of webserver functions 40 reported to an end user or developer and which are associated with the function calling pattern 70.

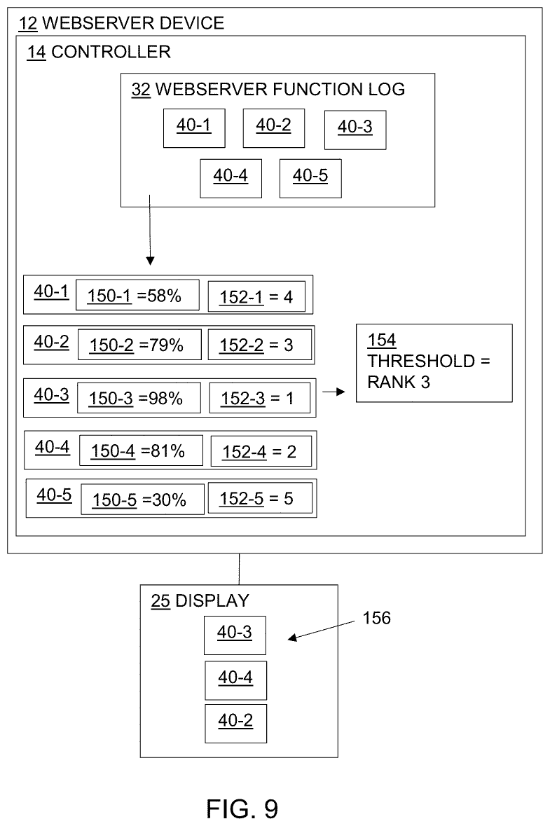

For example with reference to FIG. 9, following the identification of a number of webserver functions 40-1 through 40-5 of a set of webserver functions 40 of a function calling pattern 70, the webserver device 12 is configured to detecting a probability statistic 150 associated with each webserver function 40-1 through 40-5. The probability statistic 150 of each webserver function 40-1 through 40-5 relates to a probability of each webserver function 40-1 through 40-5 as including a logic defect 72 relative to a content request 28. The webserver device 12 can assign the probability statistic 150 to each webserver function 40-1 through 40-5 in a variety of ways. For example, webserver functions 40 which pass a greater number of exploitative content requests 28 to the database 22 can be assigned a higher probability statistic value relative to webserver functions 40 which pass a relatively lower number of exploitative content requests 28 to the database 22.

Next, the webserver device 12 is configured to rank each webserver function according to the probability statistic 150. For example, the webserver device 12 can assign each of the webserver functions 40-1 through 40-5 with a rank score 152-1 through 152-5 according to an associated decreasing probability statistic value. As such, the webserver device 12 assigns the webserver functions 40 having a higher probability statistic value 150 with a lower rank score 152 and assigns the webserver functions 40 having a lower probability statistic value 150 with a higher rank score 152.

Next, the webserver device 12 is configured to displaying a list 156 of the webserver functions of the set of webserver functions 40 that meet a probability statistic threshold 154. For example, as shown, the probability statistic threshold 154 indicates that webserver functions 40-1 through 40-5 having a rank value of three or lower can be forwarded to the display. With application of the probability statistic threshold 154, the webserver device 12 can reduce number of functions 40 related to a function calling pattern 70 which are displayed to an end user or developer, thereby making the annotation process more manageable.

While various embodiments of the innovation have been particularly shown and described, it will be understood by those skilled in the art that various changes in form and details may be made therein without departing from the spirit and scope of the innovation as defined by the appended claims.

What is claimed is:

1. In a webserver device, a method for identifying a logic defect in a webserver application, comprising:
establishing a webserver instance of the webserver device with a client device, the webserver instance of the webserver device having a corresponding set of client device permissions;
receiving a content request from the client device associated with the webserver instance of the webserver device;
detecting a violation of a permission of the set of client device permissions associated with the webserver instance of the webserver device;
identifying at least one webserver function associated with the violation of the permission of the set of client device permissions; and
displaying a visual identification of the at least one webserver function associated with the violation of the permission of the set of client device permissions.

2. The method of claim 1, wherein receiving a content request from the client device further comprises:
storing the content request for the webserver instance of the webserver device in a content request log;
storing an identification of a webserver function associated with processing the content request for the webserver instance of the webserver device in a webserver function log; and
storing a permission comparison result associated with the webserver instance of the webserver device in a permission log, the permission comparison result based upon a comparison of the content request and the set of client device permissions.

3. The method of claim 2, wherein detecting the violation of the permission of the set of client device permissions associated with the webserver instance of the webserver device comprises:
reviewing the permission log associated with the webserver instance of the webserver device; and
identifying a permission comparison result that indicates the content request from the client device associated with the webserver instance of the webserver device as violating a permission of the set of client device permissions.

4. The method of claim 3, wherein identifying at least one webserver function associated with the violation of the permission comprises:
reviewing the webserver function log associated with the webserver instance of the webserver device; and
identifying a set of webserver functions that interacted with the content request associated with the violation of the permission of the set of client device permissions.

5. The method of claim 4, further comprising:
identifying a function calling pattern of the set of webserver functions that interacted with the content request that violated the permission of the set of client device permissions; and
identifying an origin webserver function of the function calling pattern, the origin webserver function defining a logic defect relative to the content request and associated with the violation of the permission of the set of client device permissions.

6. The method of claim 5, wherein identifying the function calling pattern of the set of webserver functions further comprises:
detecting a probability statistic associated with each webserver function of the set of webserver functions, the probability statistic relating to a probability of each webserver function defining the logic defect relative to the content request;
ranking each webserver function of the set of webserver functions according to the probability statistic; and
displaying a list of the webserver functions of the set of webserver functions that meet a probability statistic threshold.

7. The method of claim 4, wherein displaying the visual identification of the at least one webserver function associated with the violation of the permission comprises:
assigning a visual indicator to the at least one webserver function that interacted with the content request that violated the permission of the set of client device permissions;
displaying an identification of the at least one webserver function that interacted with the content request with the visual indicator

8. The method of claim 4, wherein displaying the visual identification of the at least one webserver function associated with the violation of the permission comprises displaying application code associated with at least one webserver function of the set of webserver functions that interacted with the content request associated with the violation of the permission of the set of client device permissions.

9. The method of claim 4, comprising:
reviewing the content request log for the content request for the webserver instance of the webserver device;
identifying the content request associated with the violation of the permission of the set of client device permissions; and
displaying the content request that violated the permission of the set of client device permissions.

10. The method of claim 9, further comprising identifying the content request as including an adversary supply input.

11. The method of claim 1, further comprising receiving user annotation input regarding the at least one webserver function associated with the violation of the permission of the set of client device permissions.

12. A webserver device, comprising:
a controller having a memory and a processor, the controller configured to:
establish a webserver instance of the webserver device with a client device, the webserver instance of the webserver device having a corresponding set of client device permissions;
receive a content request from the client device associated with the webserver instance of the webserver device;
detect a violation of a permission of the set of client device permissions associated with the webserver instance of the webserver device;
identify at least one webserver function associated with the violation of the permission of the set of client device permissions; and
display a visual identification of the at least one webserver function associated with the violation of the permission of the set of client device permissions.

13. The webserver device of claim 12, wherein when receiving a content request from the client device, the controller is further configured to:
store the content request for the webserver instance of the webserver device in a content request log;
store an identification of a webserver function associated with processing the content request for the webserver instance of the webserver device in a webserver function log; and
store a permission comparison result associated with the webserver instance of the webserver device in a permission log, the permission comparison result based upon a comparison of the content request and the set of client device permissions.

14. The webserver device of claim 13, wherein when detecting the violation of the permission of the set of client device permissions associated with the webserver instance of the webserver device, the controller is configured to:
review the permission log associated with the webserver instance of the webserver device; and
identify a permission comparison result that indicates the content request from the client device associated with the webserver instance of the webserver device as violating a permission of the set of client device permissions.

15. The webserver device of claim 14, wherein when identifying at least one webserver function associated with the violation of the permission the controller is configured to:
review the webserver function log associated with the webserver instance of the webserver device; and
identify a set of webserver functions that interacted with the content request associated with the violation of the permission of the set of client device permissions.

16. The webserver device of claim 15, wherein the controller is further configured to:
identify a function calling pattern of the set of webserver functions that interacted with the content request that violated the permission of the set of client device permissions; and
identify an origin webserver function of the function calling pattern, the origin webserver function defining a logic defect relative to the content request and associated with the violation of the permission of the set of client device permissions.

17. The webserver device of claim 16, wherein when identifying the function calling pattern of the set of webserver functions the controller is further configured to:
detect a probability statistic associated with each webserver function of the set of webserver functions, the probability statistic relating to a probability of each webserver function defining the logic defect relative to the content request;
rank each webserver function of the set of webserver functions according to the probability statistic; and
display a list of the webserver functions of the set of webserver functions that meet a probability statistic threshold.

18. The webserver device of claim 15, wherein when displaying the visual identification of the at least one webserver function associated with the violation of the permission the controller is configured to:
assign a visual indicator to the at least one webserver function that interacted with the content request that violated the permission of the set of client device permissions;
display an identification of the at least one webserver function that interacted with the content request with the visual indicator

19. The webserver device of claim 15, wherein when displaying the visual identification of the at least one webserver function associated with the violation of the permission the controller is configured to display application code associated with at least one webserver function of the set of webserver functions that interacted with the content request associated with the violation of the permission of the set of client device permissions.

20. The webserver device of claim 15, wherein the controller is configured to:
review the content request log for the content request for the webserver instance of the webserver device;
identify the content request associated with the violation of the permission of the set of client device permissions; and
display the content request that violated the permission of the set of client device permissions.

21. The webserver device of claim 20, wherein the controller is further configured to identify the content request as including an adversary supply input.

22. The webserver device of claim 12, wherein the controller is further configured to receive user annotation input regarding the at least one webserver function associated with the violation of the permission of the set of client device permissions.
